(19) United States
(12) Patent Application Publication
(10) Pub. No.: US 2013/0334374 A1
(43) Pub. Date: Dec. 19, 2013

(54) Modular Fastening System

(71) Applicants: Frank Notaro, Southold, NY (US); Samuel J. Notaro, Syracuse, NY (US)

(72) Inventors: Frank Notaro, Southold, NY (US); Samuel J. Notaro, Syracuse, NY (US)

(21) Appl. No.: 13/527,171

(22) Filed: Jun. 19, 2012

(51) Int. Cl. F16L 3/08

(52) U.S. Cl. 248/65

(57) ABSTRACT

A modular fastening system includes a plurality of connecting units. Each connecting unit having at least one male connector at a first end and a female connector at an opposite second end. The male connector having an exterior fluted surface and the female connector having an interior fluted surface to form one connecting unit that can be configured and dimensioned in various confutations and to have various angles. The system will include at least one bracket member that is connectable to a connecting unit and is configured to support an electrical or fluid conduit.

### BACKGROUND

1. Field of the Invention

The present invention relates to brackets for supporting pipes and/or cables, and more particularly to a modular system with an adjustable configuration to fit various hanging and enclosure requirements.

2. Background of the Art

The growth of the use of telecommunication and electronic devices in homes and offices has resulted in an increase in the number of cables and wires that need to be used to connect the devices. Buildings typically need to provide support structures in walls, ceilings and various enclosures to support electrical as well as plumbing used in new construction or in remodeling of offices and homes. In particular, it is necessary to support multiple cables, wires harnesses, hot and cold-water plumbing as well as heating pipes used in different building structures.

For example, U.S. Pat. No. 6,572,058 to Gerardro is directed to a multiple cable support bracket and discloses a support member having a first portion which includes a bracket portion that is preferably configured to have a vertical orientation. The first bracket portion includes one or more openings through which screws, bolts or nails may be driven to secure the bracket to an adjacent structure. A cable support arm extends outward from the bracket portion. This portion also has a further portion which extends parallel to the bracket portion and a further segment which extends back toward the bracket portion to form a cavity within which one or more cables and/or wires may be located. The preferred bracket support of the Gerardo patent also preferably includes a centrally located spacer arm that may be utilized to provide further support for wires and/or cables located with in the cavity formed by the support arm while also separating the various cables and/or wires located with the support member.

U.S. Pat. No. 8,183,471 to Handler discloses a cable raceway including top and bottom walls, rear and front walls and a divider extending along substantially the entire length of the raceway. The divider extends in the direction between the top and bottom walls of the raceway. The raceway is comprised of a rear module of the raceway and the next module outward is a front module completing the preceding module passages. A cover over the front module passage completes that passage.

However, there is yet need for a fastening system for supporting electrical/computer wires and cables, hot and cold water pipes, duct work, gas conduits and other electrical or fluid conduits, which can be conveniently used in a variety of different building enclosures. In particular, what is needed is a modular system with multiple components which can be connected in different configurations and adapted to fit into various enclosures, soffit raceways, cabinets, wall units, under modular and stationary desk units, crown molding enclosures, behind drywalls as well as concealed in other finishing elements, in lieu of traditional building materials.

### SUMMARY

A modular fastening system is provided herein which comprises (a) a plurality of connecting units, each connecting unit having at least one male connector at a first end and a female connector at an opposite second end, the male connector having an exterior fluted surface and the female connector having an interior fluted surface, the female connector of one connecting unit being configured and dimensioned to removably receive the male connector of an adjacent connecting unit; and (b) at least one bracket member which is connectable to a connecting unit at various predetermined angles and the bracket member being configured to support an electrical or fluid conduit.

Also provided herein is a kit including the modular fastening system.

### BRIEF DESCRIPTION OF THE DRAWINGS

Various embodiments are described below with reference to the drawings wherein:

FIGS. 1 and 2 illustrate frames of the modular fastening system of the invention;

FIG. 3 is a perspective view of two joined connecting units of the modular fastening system of the invention;

FIGS. 4 and 5 are perspective views of an adapter component of the modular fastening system of the invention;

FIG. 6 is a perspective view of a bracing component of the modular fastening system of the invention;

FIG. 7 is a perspective view illustrating the bracing component assembled with the joined connecting units;

FIG. 8 is a bottom view of the assembled components of FIG. 7;

FIG. 9 is a perspective view of a support bracket of the modular fastening system of the invention;

FIG. 10 is a perspective view of a large pipe support bracket of the modular fastening system of the invention;

FIG. 11 is a perspective view of a cap member of the modular fastening system of the invention;

FIG. 12 is a perspective view of a collar of the modular fastening system of the invention;

FIG. 13 illustrates a kit including the modular fastening system of the invention;

FIG. 14 is a perspective view of a base unit;

FIG. 15 is a perspective view of a 45-degree support assembly for a crown molding;

FIG. 16 is a perspective view of a crown molding attachment bracket;

FIG. 17 is a plan view illustrating the attachment of a crown molding; and

FIG. 18 is an alternative embodiment of the crown molding attachment bracket.

### DETAILED DESCRIPTION OF THE DRAWINGS

The exemplary embodiments of the modular component system are discussed in terms of building components and more particularly, in terms of a building fastening system for new construction and remolding of offices and home construction. It is envisioned that professional builders as well as do-it-yourself construction projects can use the modular component system. For example, the modular component system and method of use can include modular interconnection pieces that are arrangable at multiple angles so that the system can be used in large construction projects as well as small construction projects.

The present disclosure may be understood more readily by reference to the following detailed description of the disclosure taken in connection with the accompanying drawing figures, which form a part of this disclosure. It is to be understood that this disclosure is not limited to the specific devices, methods, conditions or parameters described and/or shown herein, and that the terminology used herein is for the purpose of describing particular embodiments by way of example only and is not intended to be limiting of the claimed disclosure. Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure. For example, the references “upper” and “lower” are relative and used only in the context to the other, and are not necessarily “superior” and “inferior”. It will be understood that any numerical range recited herein is intended to include all sub-ranges within that range.

It will be further understood that any compound, material or substance which is expressly or implicitly disclosed in the specification and/or recited in a claim as belonging to a group of structurally, compositionally and/or functionally related compounds, materials or substances includes individual representatives of the group and all combinations thereof.

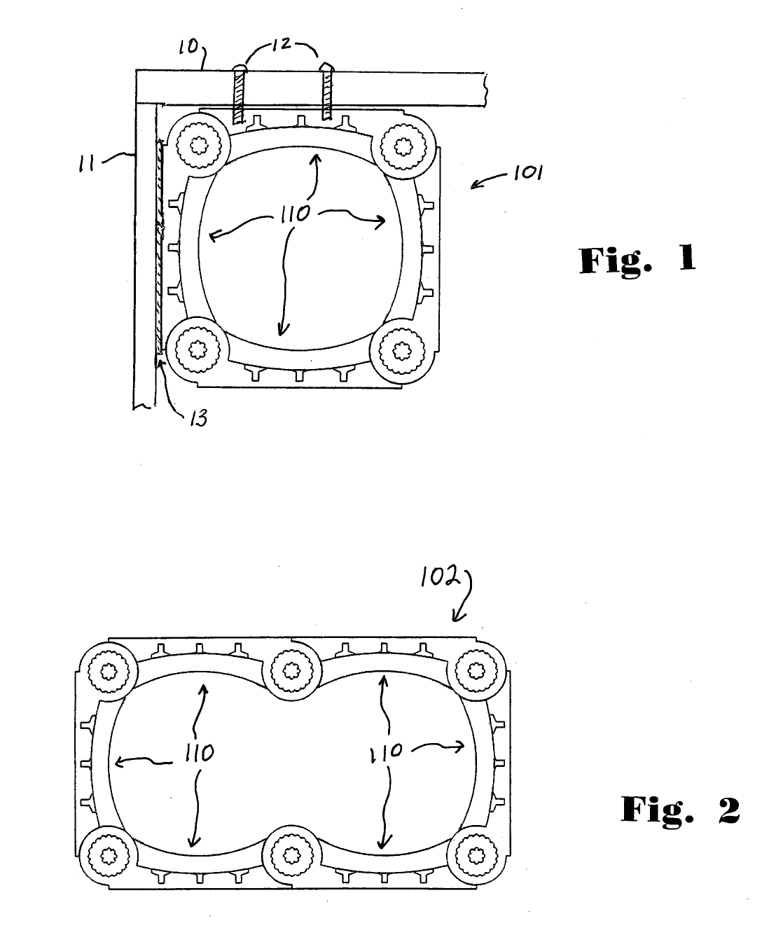

The following discussion includes a description of a modular fastening system and related methods of employing the modular fastening system in accordance with the principles of the present disclosure. Alternate embodiments are also disclosed. Reference will now be made in detail to the exemplary embodiments of the present disclosure, which are illustrated in the accompanying figures. Turning now to FIGS. 1-13, there are illustrated components of a modular fastening system in accordance with the principles of the present disclosure.

Referring now to FIGS. 1 and 2, connecting units 110 (described more fully below) may be assembled in various configurations such as triangles, trapezoids, polygrams etc. To form these shapes at least two modular components are connected together at particular angles in order to achieve the desired configuration. For example, square frame 101 can be formed by connecting four substantially straight connecting units 110 to form a square shape. In the alternative, frame 101 can be formed by connecting two triangle portions to form the square. Frame 102 can be formed by connecting six connecting units 110 to form a rectangular shape. Alternatively, three connecting units 110 can be connected to form a triangular shape. Other shapes for the frames can include, for example, trapezoids, parallelograms and various other configurations.

Referring to FIGS. 1 and 2, the frames 101, 102 can be fixed underneath a construction member such as a soffit 10 and/or to a sideboard or drywall 11 by means of any appropriate fasteners 12 such as screws, nails, etc. Alternatively, the frames 101, 102 can be secured to the construction member by a suitable construction adhesive, Velcro®, clips, straps, adhesive tape, and any combination thereof. For example, the system can be fastened to building studs/framing to brace wiring and/or water pipes to the framing of the building. Once in place the fastened system attaching wiring, pipes or other essential infrastructure to the building frame can then be concealed with drywall or other building materials. In particular as shown in FIG. 1 Velcro® type hook and loop strips 13, can be employed as a means of attaching a frame to a construction member. Velcro® type hook and loop strips can also be used to attach crown molding, drywall, or a panel over the modular fastening system holding plumbing or electrical harnesses so as to hide the structure.

As described further in FIG. 9 and FIG. 10, various types of brace components can be used in frames 101 and 102 that are configured to connect across the unit either diagonally, vertically, horizontally or at a particular angle in order to provide support for the plumbing or electrical harnesses supported by the fastening system.

Referring now to FIG. 3, two connecting units 110 are illustrated in a joined configuration. The connecting units 110 are formed as integral single piece units by molding, casting and/or machining. Each connecting unit includes an arm 111 with opposite end portions 115 and 118. Arm 111 is an elongated portion including a back 112 optionally having a plurality of grooves 113. A ridge 114 extends laterally from the back 112 and has an inward facing edge 114a which can be rectilinear or curved (as shown). The first end portion 115 includes a first cylindrical portion 116, a male connector, having a fluted outer circumferential surface 116a possessing a plurality of vertical grooves, and an axial bore 116b defined by a fluted interior surface and serving a female port for the engagement of a cap member 160, described below. The first end portion 115 also includes a second cylindrical portion 117 having a smooth circumferential outer surface 117a. The diameter of the second cylindrical portion 117 is greater than that of the first cylindrical portion 116 so as to define an annular abutment surface 117b. The second cylindrical portion further includes an axial recess 117c defined by a fluted interior surface (shown in FIG. 8). The first cylindrical portion 116 extends from a horizontal midline of the connecting unit 110 to the top, (as shown) and the second cylindrical portion extends from the midline to the bottom and is coaxial with the first cylindrical position.

The second end portion 118 is a C-shaped member, a female connector, having a smooth outer surface 118a and a fluted interior surface 118b. The C-shaped member 118 extends from about the horizontal (as shown) midline of the connecting unit 110 to the top thereof. The back 112 of the arm terminates in a curved end surface 119 in the vicinity of the second end portion 118.

The connecting units 110 can be assembled by inserting the fluted first cylindrical portion 116 at the first end 115 of one connecting unit 110 into the C-shaped second end portion 118 of another connecting unit. The fluted exterior surface 116a of one connecting unit 110 is configured to correspondingly engage the interior fluted surface 118b of the C-shaped second end portion so as to prevent relative rotation of the two connecting units when assembled. However, because the fluted surfaces contain a plurality of vertical grooves and ridges, the orientation of the two connecting units can be selected during the assembly process so that the arms 111 can be configured in a variety of different angular relationships. As shown, angle A defined by the two arms 111 can be almost any degrees with the only limitation on the gearing of the fluted surfaces. That is, the fluted surfaces can be designed so that moving the connecting portion from one fluted surface to an adjacent fluted surface creates a new structure having a defined change in degrees. The more ridges in the fluted surface, the greater the number of different degrees that can be created. For example, if the fluted surface has only four ridges located at 90 degrees apart, the connectors that connect to the fluted piece would be able to be form angles of 90, 180, and 270 degrees between components. Doubling the number of ridges on the fluted piece would double the number of angles that can be achieved. Increasing the number of ridges on the connector directly increases the number of possible angles that can be achieved by the fastening component system.

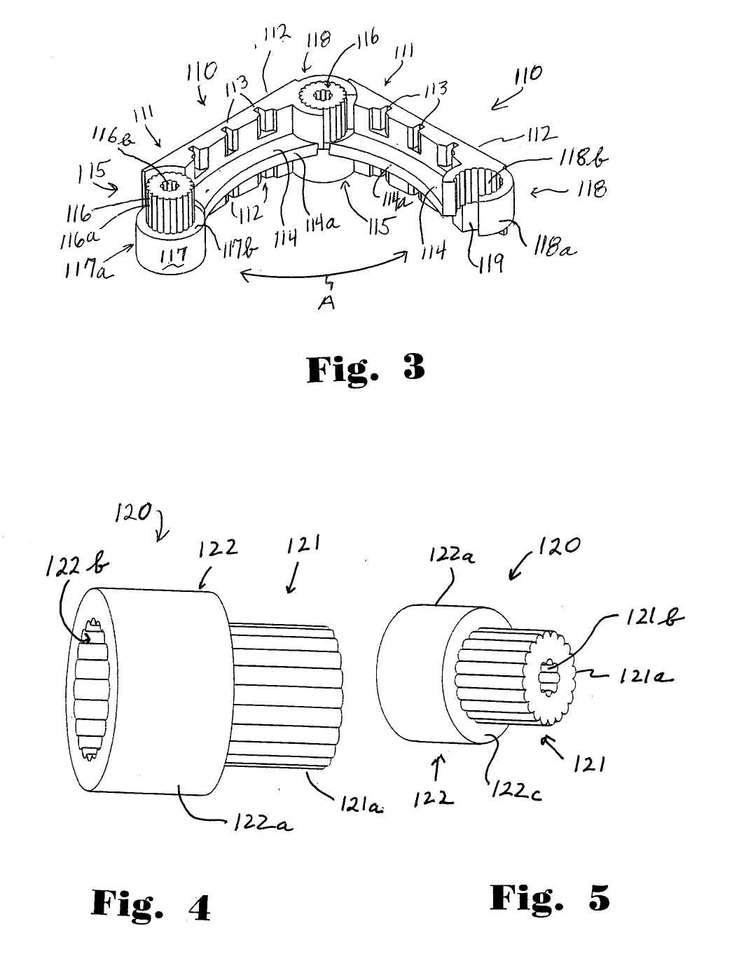

Referring now to FIGS. 4 and 5, an adapter 120 includes a first cylindrical portion 121 including an exterior circumferential fluted surface 121a and an axial bore 121b defined by an interior fluted surface and serving as a female port for the engagement of a cap member 160 as described below. Second cylindrical portion 122 has a circumferential smooth exterior surface 122a and an axial recess 122b defined by an interior fluted surface. The second cylindrical portion 122 is coaxially aligned with the first cylindrical portion 121 and is a larger diameter so as to define an annular abutment 122c. The adapter is preferably of monolithic piece construction and can be fabricated from any of the materials described below by any of the methods described below.

FIG. 6 is a brace 130 and includes a rectilinear bar 131 and opposite end portions 132 each including a cylindrical male connector 133 having a circumferential fluted surface 133a. Male connector 133 is configured to engage a female reception port such as axial recess 122b of the adapter 120 or C-shaped end portion 118 or axial recess 117c of the second cylindrical portion 117 of the connecting unit 110. The brace 130 is preferably of monolithic piece construction and can be fabricated from any of the materials described below by any of the methods described below.

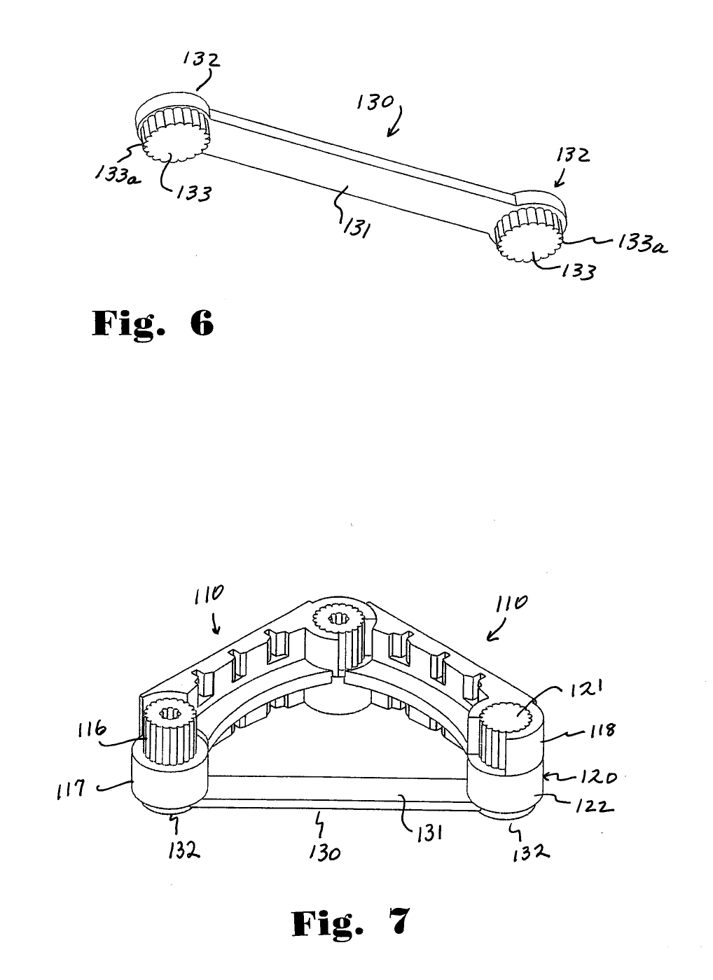

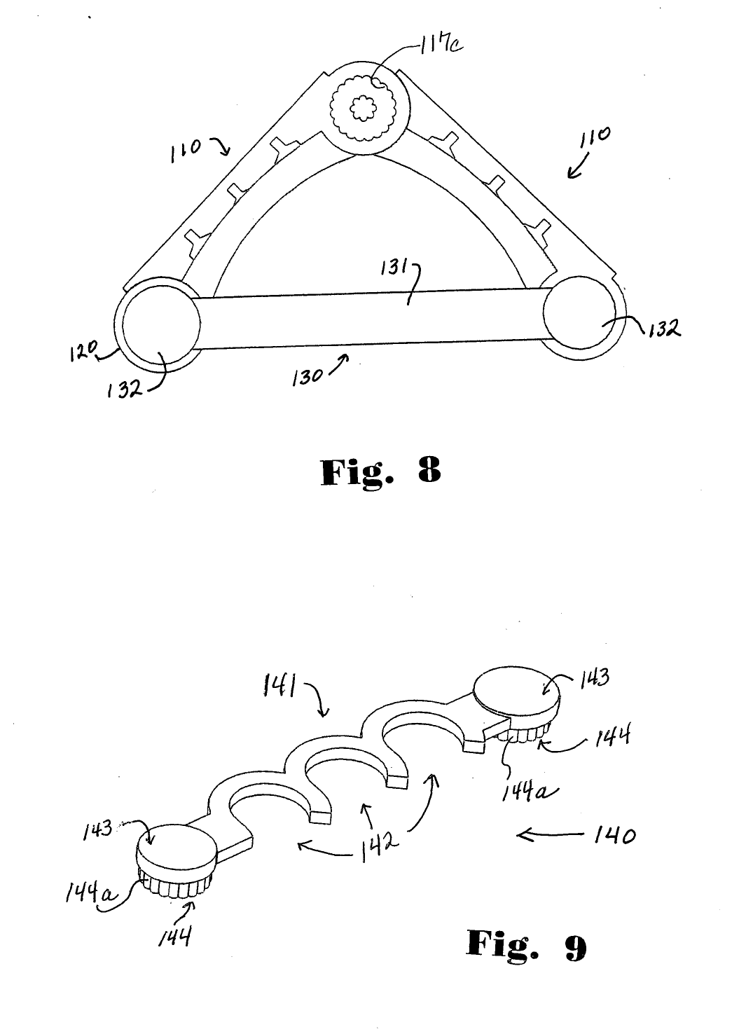

Referring now to FIGS. 7 and 8, a braced frame is illustrated wherein two connecting units are connected to each other as shown in FIG. 3. Adapter 120 is engaged with the C-shaped second end portion 118 of one of the connecting units such that the male connector, i.e., fluted cylindrical portion 121 of the adapter is engaged in the interior of the C-shaped portion defined by fluted surface 118b. The brace 130 extends from the first end portion of one connecting member 110 to the second end portion of the other connecting member 110. As can be seen, the male connector 132 at one end of the brace 130 is engaged in the, female port, i.e. the fluted recess 117c of the second cylindrical portion 117 of one connecting member 110 and the male connector 132 at the other end of the brace 130 is engaged in the female part, i.e., fluted axial recess 122b (FIG. 4) of the adapter 120, which is engaged with the second end portion of the other connecting member 110, as mentioned above.

Referring to FIG. 9, support bracket 140 includes a middle support section 141 and opposite end portions 143, each end portion including a male connector 144 having a circumferential fluted surface 144a which is configured and dimensioned to engage a female reception port such as axial recess 122b (FIG. 4) of the adapter 120 (FIG. 4) or C-shaped end portion 118 (FIG. 3) or axial recess 117c (FIG. 8) of the second cylindrical portion 117 (FIG. 3) of the connecting unit 110 (FIG. 3). The middle support section 141 includes at least one, and preferably several hook portions 142 for supporting wires, cables, tubes, pipe or other electrical or fluid conduits. The hook portions 142 can be C-shaped, as shown in FIG. 9. Alternatively, the hook portions 142 can possess a substantially rectangular or triangular configuration, i.e., having a crenelate or sawtooth structure. In this embodiment the bracket support 140 can include 3 hook portions. In another embodiment the bracket support 140 can include two or more groups of hook portions, each group including from 1 to 5 hook portions, the groups being spaced apart from each other along the length of the middle support section 141. The support bracket 140 is preferably of single piece construction and can be fabricated from any of the materials described below by any of the methods described below.

Referring now to FIG. 10, large pipe support bracket 150 comprises a body 151 defining a central opening 152 and a gap 153 so as to provide body 151 with a C-shaped configuration. Large pipe support bracket 150 includes one or more projections 154 extending outward from the circumferential periphery of the body 151. Each projection 154 includes a base portion 154a having a smooth circumferential surface and a male connector 154b having a fluted circumferential surface 154c which is configured and dimensioned so as to engage a female reception port such as axial recess 122b (FIG. 4) of the adapter 120 (FIG. 4) or C-shaped end portion 118 (FIG. 3) or axial recess 117c (FIG. 8) of the second cylindrical portion 117 (FIG. 3) of the connecting unit 110 (FIG. 3). The central opening 152 is configured and dimensioned so as to accommodate a large pipe or tube disposed therethrough and typically has a diameter of from about 1 inch to about 3 inches, although dimensions outside of this range can be employed whenever appropriate. The large pipe support bracket 150 is preferably of monolithic piece construction and can be fabricated from any of the materials described below by any of the methods described below.

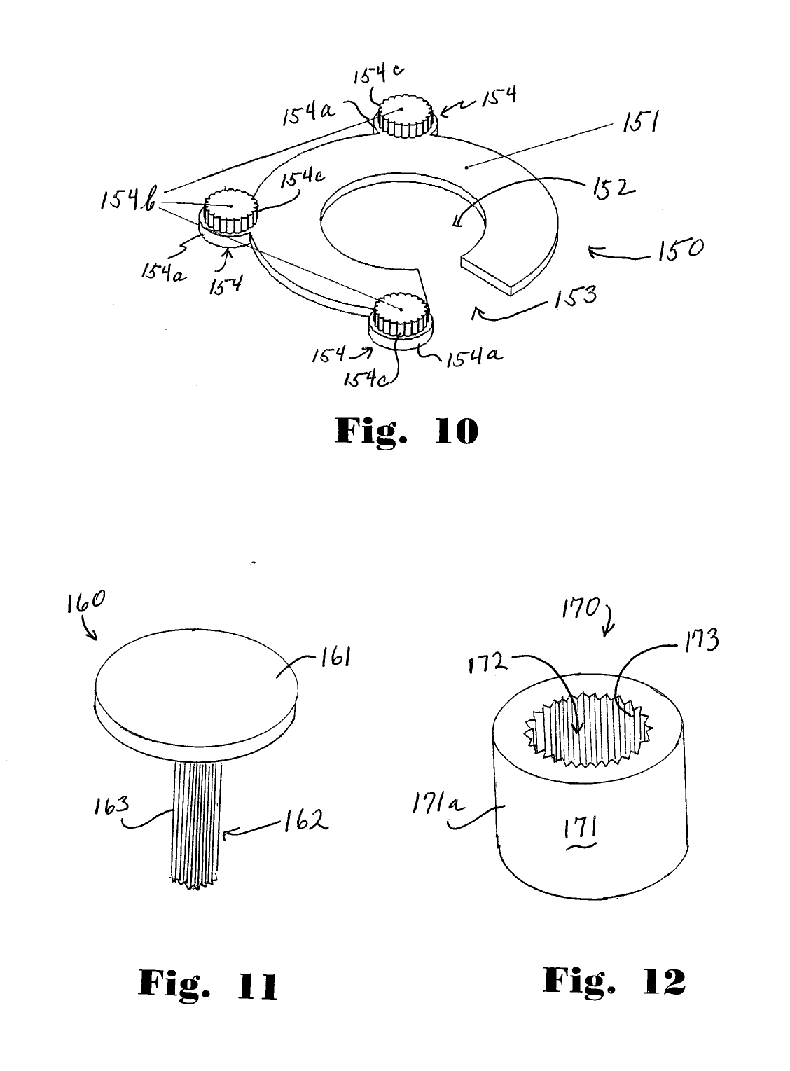

Referring to FIG. 11, a cap member 160 includes a flat, disk shaped top surface 161 and an elongated axially extending male connector 162 having a fluted surface 163. The male connector 162 is configured and dimensioned so as to engage female port 116b (FIG. 3) of the connecting unit 110 (FIG. 3) or the female port 121b (FIG. 5) of the adapter 120 (FIG. 5). The cap member 160 is preferably of monolithic single piece construction and can be fabricated from any of the materials described below by any of the methods described below.

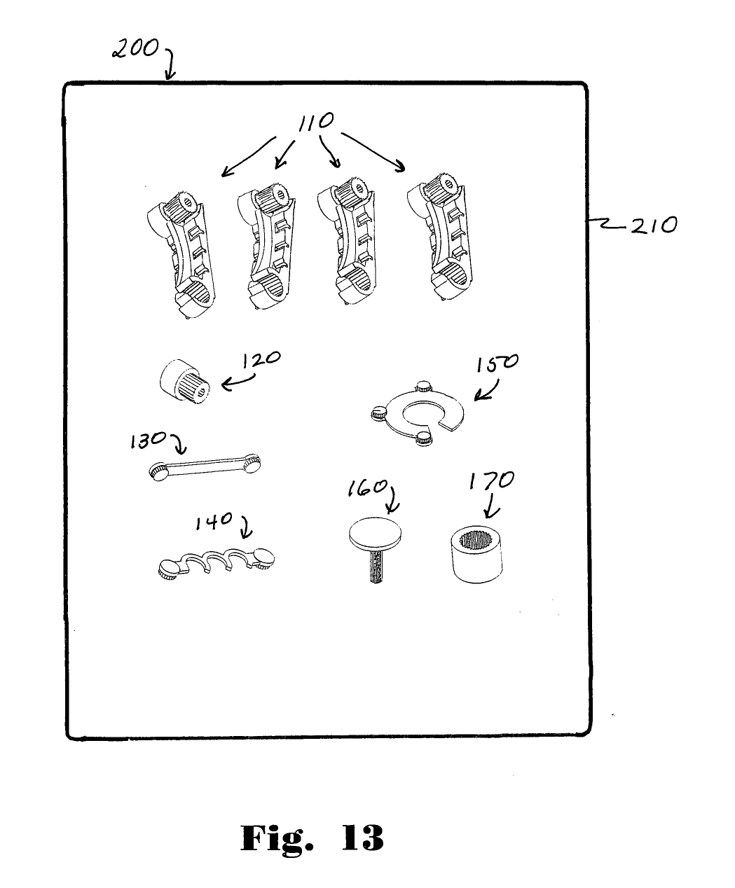

Referring to FIG. 12, collar 170 includes a cylindrical body having a smooth circumferential outer surface 171a and an axial channel 172 defined by a fluted interior surface 173. The axial channel 172 serves as a female port which is configured and dimensioned so as to engage any of the male connectors 116 (FIG. 3), 121 (FIG. 5), 133 (FIG. 6), 144 (FIG. 9), or 154b (FIG. 10). The collar 170 is preferably of monolithic piece construction and can be fabricated from any of the materials described below by any of the methods described below.

The components of the modular fastener system can be assembled and packaged in the form of a kit containing at least about two and preferably from about six to twelve connecting units 110 (FIG. 3), at least two and preferably four to eight adapters 120 (FIG. 5), at least one and preferably two to four braces 130 (FIG. 6), at least one and preferably two to four support brackets 140 (FIG. 9), at least one and preferably two to four large pipe support brackets 150 (FIG. 10), at least two and preferably four to eight caps 160 (FIG. 11), and at least two and preferably four to eight collars 170 (FIG. 12). This is one embodiment of the kit but it is within the scope of the invention that different size kits can be assembled. In addition, it is also within the scope of this disclosure that different kits can be complied according to the particular use. For example, kits designed to support wires under a desk can include angled pieces, tubing and attachable brackets for fastening the system to the underside of the desk.

The connecting units typically can be from three to five inches in length and from about ¾ inch to about one inch in width To use the modular system of the invention, the user first determines the size and configuration of a frame to be made in accordance with the space available for its location and the loading of cables, wires, pipes, tubes, etc. it is required to support. The user then assembles a frame by joining the connecting units end to end. An important feature of the invention is that the fluted surfaces of the male connectors and female ports allows the user to create a variety of frame configurations because the joints between the connecting units can be set at angles ranging from 15 degrees to 180 degrees. The frame can be attached to the construction member (e.g., a soffit, wallboard, etc.) by any of the means mentioned above such as with individual fasteners, adhesive, Velcro® strips, etc. Bracing and brackets, caps and collars can be selected as needed and assembled with the frame. Typically, part of the frame is attached to the construction member and the remainder of the frame is constructed around the cables, wires, pipes and tubing.

Referring now to FIG. 13 a kit 200 includes the modular fastening system of the packaged within a container 210, which can be a soft container, such as a plastic or fabric bag, or a hard container such as a metal, wood, or hard plastic box. The packaged kit includes at least two and optionally four to twelve connecting units 110, at least one and optionally two to four support brackets 140 and at least one, and optionally two to four large pipe support brackets 150. Kit 200 can also include one or more adapters 120, one or more brace members 130, one or more caps 160 and one or more collars 170. The kit 200 can optionally also include attachment devices such as screws, Velcro® strips and adhesive.

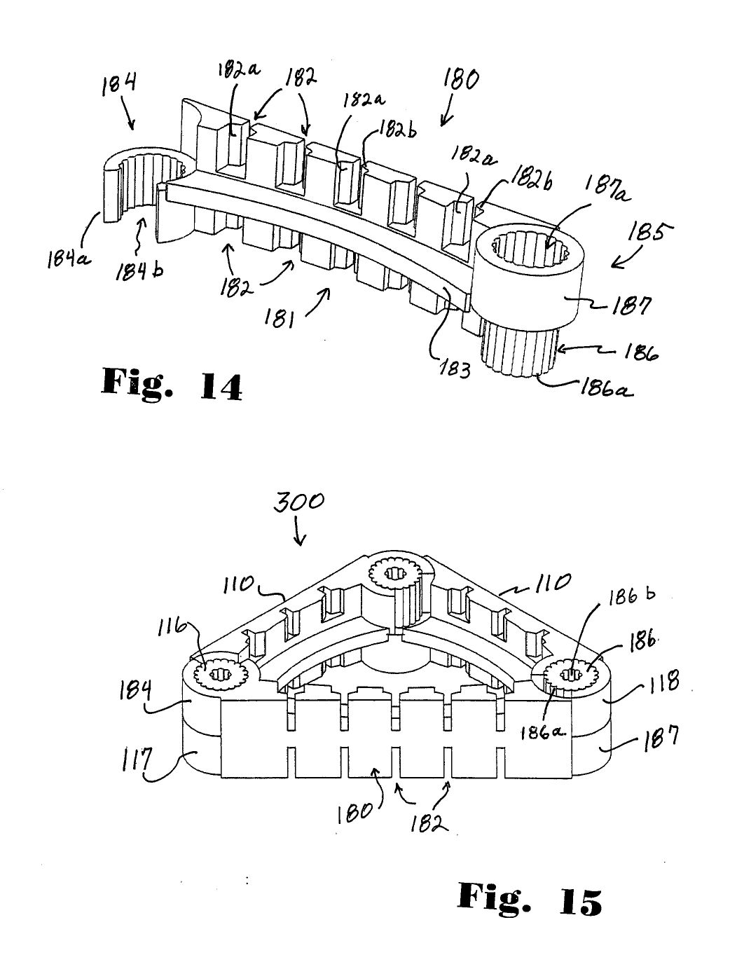

Referring now to FIGS. 14 and 15, a base unit 180 includes an arm 181 including a plurality of vertical slots 182 and a laterally extending horizontal ridge 183. Each slot 182, unlike grooves 113 of the connecting units 110, is open so as to permit the legs 192 of a crown molding attachment bracket (described below) to be laterally disposed therethrough. Each slot 182 is at least partially defined by opposite stop surfaces 182a and 182b, the function of which is described below in connection with the crown molding attachment bracket. Slots 182 are disposed both above and below the laterally extending ridge 183 and are horizontally spaced apart from each other at regular intervals. Base unit 180 further includes a first end portion 184 comprising a C-shaped member 184a having a fluted interior surface 184b. A second end portion 185 at an opposite end of the arm 181 comprises a cylindrical portion 186 having a fluted outer surface 186a and an axial bore 186b defined by an interior fluted surface. Second end portion 185 also includes a cylindrical portion 187 having an axial channel 187a defined by an interior fluted surface 187a. Cylindrical portions 186 and 187 are coaxially arranged. Cylindrical portion 186 is configured and dimensioned so as to be engaged in C-shaped end portion 118 of a connecting unit 110. Cylindrical portion 187 is configured to receive first cylindrical portion 116 of a connecting unit 110 in channel 187a. Base unit 180 is of integral single piece construction of materials described herein. The length of the base unit 180 is about 1.414 times the length of the individual connecting units 110 such that, when connected therewith to form a support assembly 300 as shown in FIG. 15, the angles at which each end of the base unit 180 is connected to a respective connecting unit 110 is 45 degrees. The angle at which the two connecting units 110 are connected to each other is 90 degrees. Thus, the support assembly 300 forms a 90-45-45 degree triangle.

Referring now to FIGS. 3 and 15 support assembly 300 is formed by connecting units 110 as shown in FIG. 3 such that angle A is 90 degrees. End portion 184 is connected to cylindrical portion 116 of one connecting unit 110 and cylindrical portion 186 of the base unit 180 is connected to the C-shaped end portion 118 of the other connecting unit 110.

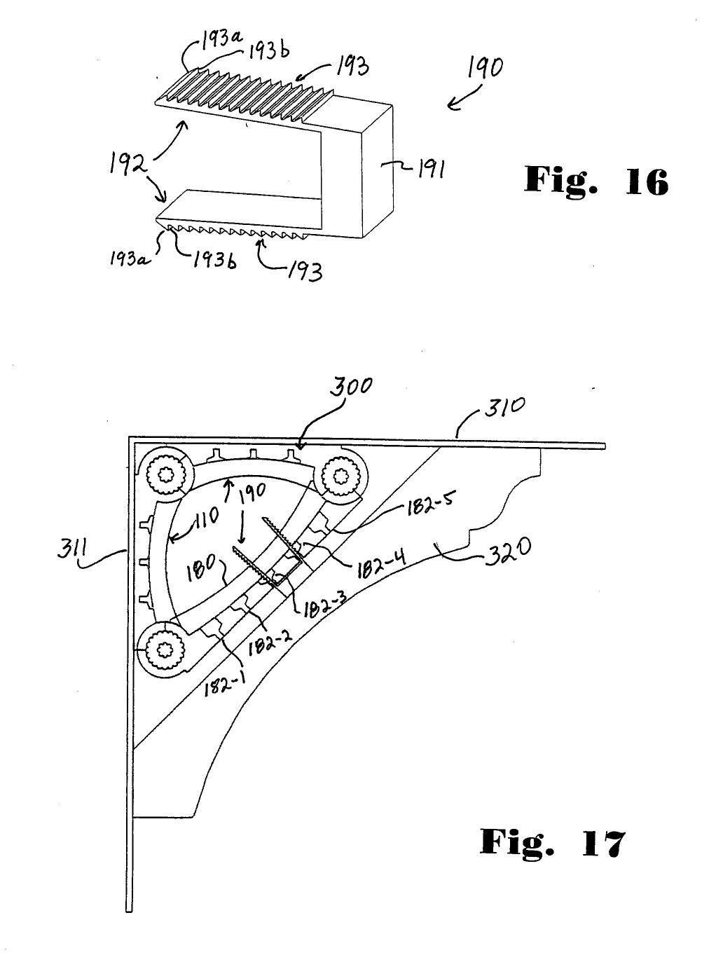

Referring now to FIG. 16, a crown molding attachment bracket 190 is a generally U-shaped member of integral single piece construction of materials discussed herein. Bracket 190 includes a back portion 191 from which legs 192 extend in a spaced apart substantially parallel configuration. Legs 192 are flat members each having a planar outer surface with a plurality to saw-tooth lateral ridges 193 in a parallel array extending along the length of the legs 192. The saw-tooth ridges each include an inclined forward surface 193a and a rear surface 193b orthogonal to the outer surface of the respective leg. Crown molding attachment bracket 190 is configured to be inserted into slots 182 of the base unit 180 such that legs 192 are respectively disposed through adjacent slots 182. As can be readily appreciated, the inclined forward surfaces 193a of the sawtooth ridges 193 permit the forward insertion of legs 192 through slots 182. However, once the legs 192 are engaged in a respective slot, the legs cannot easily be withdrawn because the rear surfaces 193b will abut stop surfaces 182a and 182b of the slot. Accordingly, movement of the legs 192 through the slots 182 is permitted in only one direction, which secures the engagement of the crown molding attachment bracket 190 with the base unit 180 to prevent further relative movement between them.

Referring now to FIG. 17, a crown molding 320 is mounted to a support assembly 300, which is mounted to the corner of a soffit 310 and a side wall 311. The crown molding 320 is fixed to the support assembly 300 by means of the crown molding attachment bracket 190, to which the crown molding is connected by means of an appropriate fastener after insertion of the bracket 190 into the base unit 180. As shown in FIG. 17, the base unit 180 possesses several slots, 182-1, 182-2, 182-3, 182-4 and 182-5. The user of the invention can select which slots to be used to engage the crown molding attachment bracket 190 according to the relevant conditions. For example, as shown, the crown molding attachment bracket 190 is inserted through slots 182-3 and 182-4. However, the angle between the soffit 310 and side wall 310 might not be perfectly orthogonal. As an alternative, the crown molding attachment bracket can be inserted through slots 182-1 and 182-2, which would allow more flexibility for the combined support assembly 300 crowning molding 320 to bend or “give” in order to accommodate a minor deviation of the soffit-side wall angle from true orthogonal relationship. Furthermore, the depth of penetration of the crown molding attachment bracket 190 into the base unit 180 can be varied to accommodate minor construction variations. As stated above, the saw-tooth ridges 193 of the crown molding attachment bracket 190 prevent disengagement. Accordingly, once inserted to a certain depth, the crown molding attachment bracket 190 will stay at least at that depth.

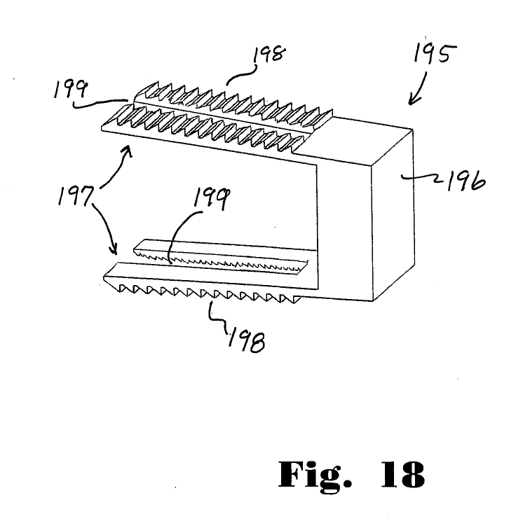

Referring to FIG. 18, an alternative embodiment 195 of the crown molding attachment bracket is shown. Embodiment 195 is similar to bracket 190 in that it includes a back portion 196, two parallel flat legs 197 so as to form a generally U-shaped configuration, and saw-tooth ridges 198 similar to ridges 193 of the crown molding attachment bracket 190. However, embodiment 195 differs in that each leg 197 includes a lengthwise slot 199. Referring briefly to FIG. 14, it can be seen that the upper slots and lower slots 182 of the base unit 180 are separated by a ridge 183. Accordingly, the crown molding attachment bracket 190 as shown in FIG. 16 can be inserted through either two adjacent upper slots or two adjacent lower slots, but not both. However, slot 199 is configured to accommodate ridge 183. Therefore, the legs 197 of crown molding attachment bracket 195 can be inserted through the vertically aligned top and bottom slots 182 of the base unit 180.

The components of the modular fastening system can be fabricated from any type of suitable material such as metal, (e.g., stainless steel, aluminum, brass, bronze, etc), or engineering plastics such as high density polyethylene plastic (HDPE), ultra high molecular weight polyethylene plastic (UHMWPE), MC cast nylon 6/66 plastic (Nylon), polytetrafluoroethylene plastic (PTFE), acrylonitrile butadiene styrene (ABS), polycarbonates (PC), polyamides (PA) polybutylene terephthalate (PBT), polyethylene terephthalate (PET), polyphenylene oxide (PPO), polysulphone (PSU), polyetherketone (PEK), polyetheretherketone (PEEK), polyimides, polyphenylene sulfide (PPS), or polyoxymethylene plastic (POM/Acetal). In an embodiment the components of the modular fastening system of the invention are fabricated from HDPE and optionally can include colored pigments or dyes. Indicia can be printed on the components so as to provide directions on how to connect the units.

The components of the fastening system can be produced using any suitable method accepted in the art such as molding, mechanical etching, chemical etching, carving, casting, machining metals, or any other method acceptable in the art that produces the desired shape from the desired material and has the desired specifications. The components of the fastening system can also be made form multiple types of materials made from different methods that are assembled to arrive at the contemplated configurations.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. A modular fastening system which comprises:
a) a plurality of connecting units, each connecting unit having at least one male connector at a first end and a female connector at an opposite second end, the male connector having an exterior fluted surface and an axial bore defined by an interior fluted surface, and the female connector having an axial channel defined by a fluted inside surface, the female connector of one connecting unit being configured and dimensioned to removably receive the male connector of an adjacent connecting unit; and
b) at least one bracket member which is connectable to a connecting unit, said bracket member being configured to support an electrical or fluid conduit.

2. The modular fastening system of claim 1 wherein the connecting units each include an elongated arm portion between the first end and the second end, wherein adjacently connected connecting units can be fixedly oriented at an angle A, wherein angle A can be from about 5 degrees to about 355 degrees.

3. The modular fastening system of claim 1 wherein the connecting units are assembled to form a frame defining an opening and the bracket member is positioned in the opening and connected to at least two connecting units.

4. The modular fastening system of claim 1 wherein the bracket member comprises an elongated body having a male connector at each of two opposite ends, each male connector comprising a cylindrical member having a fluted circumferential outer surface.

5. The modular fastening system of claim 4 wherein the bracket has a middle section between said two ends, said middle section having at least one C-shaped support for the electrical or fluid conduit.

6. The modular fastening system of claim 1 wherein the bracket member comprises a C-shaped body having at least one male connector extending from an outer periphery of the C-shaped body, the male connector comprising a cylindrical member having a fluted circumferential outer surface.

7. The modular fastening system of claim 1 further comprising an adapter having a male connector and a female connector, the male connector including a cylindrical member having a fluted outer circumferential surface and an axial bore defined by a fluted interior surface, the female connector being a cylindrical member having a smooth outer surface and an axial channel defined by a fluted inside surface, wherein the female connector and the male connector are coaxially aligned.

8. The modular fastening system of claim 7 wherein the female connector has a diameter which is wider than a diameter of the male connector, and wherein the adapter is of integral single piece construction.

9. The modular fastening system of claim 1 further comprising at least one brace including an elongated rectilinear bar having a male connector at each of two opposite ends, each male connector comprising a cylindrical member having a fluted circumferential outer surface.

10. The modular fastening system of claim 1 further comprising one or more cap member, said cap member having a disc shaped portion and an axially extending elongated male connector having an exterior fluted surface configured to be received in the axial bore of the male connector of the connecting unit.

11. The modular fastening system of claim 1 further including a collar comprising a cylindrical body having a smooth circumferential outer surface and an axial channel defined by a fluted interior surface.

12. A packaged modular fastening kit which comprises:
a) a plurality of connecting units, each connecting unit having at least one male connector at a first end and a female connector at an opposite second end, the male connector having an exterior fluted surface and the female connector having an interior fluted surface, the female connector of one connecting unit being configured and dimensioned to removably receive the male connector of an adjacent connecting unit; and
b) at least one first bracket member which is connectable to at least one connecting unit, said bracket member being configured to support an electrical or fluid conduit; and
c) at least one-second bracket member configured to support a large pipe having a diameter of at least 1 inch, said second bracket member being connectable to at least one connecting unit.

13. The kit of claim 12 wherein the connecting units each include an elongated arm portion between the first end and the second end, wherein adjacently connected connecting units can be fixedly oriented at an angle A, wherein angle A can be from about 15 degrees to about 180 degrees.

14. The kit of claim 12 wherein the bracket member comprises an elongated body having a male connector at each of two opposite ends, each male connector comprising a cylindrical member having a fluted circumferential outer surface configured to be received in the female connector.

15. The kit of claim 14 wherein the bracket has a middle section between said two ends, said middle section having at least one C-shaped support for the electrical or fluid conduit.

16. The kit of claim 12 wherein the bracket member comprises a C-shaped body having at least one male connector extending from an outer periphery of the C-shaped body, the male connector comprising a cylindrical member having a fluted circumferential outer surface.

17. The kit of claim 12 further comprising an adapter having a male connector and a female connector, the male connector including a cylindrical member having a fluted outer circumferential surface and an axial bore defined by a fluted interior surface, the female connector being a cylindrical member having a smooth outer surface and an axial channel defined by a fluted inside surface, wherein the female connector and the male connector are coaxially aligned, and wherein the female connector has a diameter which is wider than a diameter of the male connector, and wherein the adapter is of integral single piece construction.

18. The kit of claim 17 further comprising one or more cap member, said cap member having a disc shaped portion and an axially extending elongated male connector having an exterior fluted surface configured to be received in the axial bore of the male connector of the connecting unit.

19. The kit of claim 18 further including a collar comprising a cylindrical body having a smooth circumferential outer surface and an axial channel defined by a fluted interior surface.

20. An assembled modular fastening system which comprises:
a) a plurality of connecting units connected end to end to configure the frame into a predetermined shape, each connecting unit having at least one male connector at a first end and a female connector at an opposite second end, the male connector having an exterior fluted surface and an axial bore defined by an interior fluted surface, and the female connector having an axial channel defined by a fluted inside surface, the female connector of one connecting unit being configured and dimensioned to removably receive the male connector of an adjacent connecting unit, wherein the connecting units each include an elongated arm portion between the first end and the second end, wherein adjacently connected connecting units can be fixedly oriented at an angle A, wherein angle A can be from about 15 degrees to about 180 degrees; and
b) at least one bracket member which is connectable to a connecting unit, said bracket member being configured to support an electrical or fluid conduit
wherein the connecting units are assembled to form a frame defining an opening and the bracket member is positioned in the opening and connected to at least two connecting units.
